(19) United States
(12) Patent Application Publication
(10) Pub. No.: US 2009/0287479 A1
(43) Pub. Date: Nov. 19, 2009

(54) SOUND FRAME LENGTH ADAPTATION

(75) Inventors: Marek Szczerba, Eindhoven (NL); Andreas Gerrits, Oeffelt (NL); Marc Klein Middelink, Huissen (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/306,618

(22) PCT Filed: Jun. 27, 2007
(86) PCT No.: PCT/IB2007/052494

§ 371 Date: Dec. 24, 2008

(30) Foreign Application Priority Data
Jun. 29, 2006 (EP) 06116274.9

(51) Int. Cl. G10L 19/02; G10L 21/00

(52) U.S. Cl. 704/211; 704/500; 704/E19.002

(57) ABSTRACT

A method of producing time domain sound data (B) from sound parameters (A), the method comprising the steps of: forming first frames, each first frame containing sound parameters representing sound, —forming second frames from the first frames, each second frame containing transform domain sound data derived from the sound parameters, the transform domain sound data of each second frame representing sound having a specific time domain length, and each second frame having a length corresponding with an efficient inverse transform, inversely transforming the second frames into third frames (G1, G2, . . . ), each third frame containing time domain sound data corresponding to the transform domain sound data of a second frame, and each third frame having a length equal to a second frame, outputting substantially all time domain sound data (B) of each third frame, and discarding or repeating first frames (F3, F7) as necessary to compensate for any length difference between the said specific time domain length (P) and the length of the third frames (Q).

### BACKGROUND OF THE INVENTION

The present invention relates to length adaptation of sound frames. More in particular, the present invention relates to a device for and a method of producing time domain sound data from sound parameters involving a frame length adaptation to allow an efficient transform.

It is well known to synthesize or reconstruct sound from sound parameters representing sound samples. Sound synthesis in a transform domain, such as the frequency (that is, the Fourier transform) domain, provides computational advantages over sound synthesis in the time domain. For this reason, sound is often encoded and stored as sound parameters, such as spectral components or parameters representing spectral or temporal properties. Separate parameters may be provided for different sound components, such as transient components, sinusoidal components, and noise components. An encoder and a decoder in which such different sound components are used is disclosed in, for example, International Patent Application WO 01/69593 (Philips).

A synthesizer or decoder may use stored or transmitted sound parameters to assemble transform domain sound frames that are then (inversely) transformed to the time domain. The duration of the resulting time domain sound frames is typically determined by psycho-acoustic considerations and may be chosen to minimize artifacts. Some synthesizers, for example, use sound frames having a (time domain) duration of 8.7 ms. At a sampling frequency of 44.1 kHz, such frames will have a length of 384 samples.

Although this frame length of 384 data items may be optimal from the psycho-acoustic point of view, transforming such frames is very inefficient. The fast Fourier transform (FFT), its inverse (IFFT) and similar transforms, such as the discrete cosine transform (DCT), is most efficient when the number of data items in a frame is a power of two, for example 128, 256 or 512. In the present example of 384 data items per frame a transform length of 512 would be chosen. When the transform is completed, 128 data items are discarded in order to yield to the desired number of 384 data items. However, this means that the transform has an efficiency of only 75%, as 25% (=128/512) of the data items are redundant.

The efficiency of the transform may be even lower at other sampling frequencies. The duration of 8.7 ms mentioned in the above example yields 139 samples at a sampling frequency of 16 kHz. Using a transform length of 256 would result in an efficiency of only 54%.

Although embodiments of the FFT are known which are suitable for other frame lengths than powers of two, these alternative embodiments are typically less efficient and require more processing time and/or more memory.

### SUMMARY OF THE INVENTION

It is an object of the present invention to overcome these and other problems of the Prior Art and to provide a device for and a method of producing time domain output sound data from input sound data, such as sound parameters, which device and method are more efficient.

Accordingly, the present invention provides a device for producing time domain sound data from sound parameters, the device comprising:

a first frame-forming unit for forming first frames, each first frame containing sound parameters representing sound,

a second frame-forming unit for forming second frames from the first frames, each second frame containing transform domain sound data derived from the sound parameters of a single first frame, the transform domain sound data of each second frame representing sound having a specific time domain length, and each second frame having a length corresponding with an efficient inverse transform,

an inverse transform unit for inversely transforming the second frames into third frames, each third frame containing time domain sound data corresponding to the transform domain sound data of a single second frame, and each third frame having a length equal to a second frame,

an output unit for outputting substantially all time domain sound data of each third frame, and

a frame selector unit for discarding or repeating first frames as necessary to compensate for any difference between the said specific time domain length and the length of the third frames.

By using all, or nearly all, inversely transformed sound data contained in the third frames, instead of using only the number of sound data corresponding with the original specific time domain length represented by the second frames, the efficiency of the device is significantly enhanced.

It is noted that in the present invention the output unit may output all time domain sound data of each third frame, or nearly all, that is at least 90% of said time domain sound data, preferably at least 95%, more preferably at least 98%.

By discarding or, as the case may be, repeating first frames any difference between the length of the third frames and the specific time domain length represented by the transform domain data of the second frames may be compensated. For example, if a transform length of 512 is used for (first) frames having a length of 384 samples, and if all 512 inversely transformed samples are used in accordance with the present invention, then 512/384=1.33 as many samples are produced as in the Prior Art. Accordingly, the number of first frames to be used has to be reduced by 384/512=1/1.33=25%. In the present example, one out of every four frames would therefore have to be discarded to obtain sound having the same overall duration.

It has been found that discarding frames is hardly noticeable, in particular when the discarding is carried out intermittently. It is therefore preferred that the discarded frames are evenly spaced and, in particular, that discarding two directly adjacent frames is avoided (e.g. ABDEG, when the original frames series of frames was ABCDEFG). When repeating frames, however, it is preferred to repeat the next adjacent frames (e.g. ABCCDEFFG).

The specific time domain length mentioned above may be defined by a time window corresponding with a desired time duration, for example the 384 samples corresponding to the duration of 8.7 ms referred to above. In a practical embodiment, the second frame-forming unit may derive the transform domain sound data from the sound parameters by convolving the transform domain sound data represented by the sound parameters with a (segment of a) transform domain representation (e.g. a complex spectrum) of a desired time window. Oversampling may be applied to this spectral representation of the desired time window in order to improve the frequency domain resolution of the resulting signal.

The specific time domain length mentioned above is typically related to the rate at which first frames are formed and may be equal to the time interval between successive first frames. However, this is not essential and embodiments can be envisaged in which first frames are formed at varying intervals, the first frames being buffered before being converted into second frames.

In the present invention the sound parameters may comprise parameters representing sound characteristics, the transform domain sound data may comprise transform domain coefficients derived from said sound parameters, while the time domain sound data may comprise sound samples obtained from said coefficients.

The transform efficiency can be further improved by selecting a more suitable transform length. According to a further aspect of the present invention, therefore, the first frame-forming unit may be arranged for reducing or increasing the specific time duration so that the said specific time domain length is equal, or approximately equal, to the length of a third frame.

By reducing or increasing the specific time duration represented by the data of a second frame, a shortened or lengthened frame is obtained which may more closely match an efficient transform length. For example, the above-mentioned time duration of 8.7 ms yields 139 samples at a sampling frequency of 16 kHz, which would result in an efficiency of only 54% (=139/256) when using a transform length of 256. However, if this time duration is reduced to 8.0 ms, only 128 samples are required at 16 kHz, and a transform length of only 128 can be used. It will be clear that this measure significantly improves the efficiency.

It is noted that in actual embodiments the length of the specific time duration may be reduced slightly further, for example to 7.9 ms and 126 samples, for technical reasons.

As the duration of the frames may be reduced, the total duration of the sound is reduced, which is usually undesirable. For this reason, the frame selector unit comprises means for repeating (or, as the case may be, discarding) first frames as necessary to compensate for any length difference between the first frames and the second frames. By repeating frames, the total duration of the sound which is output can be kept substantially unchanged. In the above example, a first frame length reduction from 8.7 to 8.0 ms requires an adjusted length of 8.7/8.0=1.0875 (that is, adding 8.75%), which may for example be achieved by repeating one in every 12 frames (1/12=8.33%).

It has been found that the length reduction and the associated repetition of frames is hardly audible, as long as certain limits are observed. In order to avoid any clearly audible artifacts it is preferred that the first frame-forming unit comprises means for reducing the specific time duration by at most 40%, preferably at most 25%, more preferably at most 15%.

The inverse transform preferably is an inverse fast Fourier transform (IFFT), although other suitable transforms may also be used, for example an inverse discrete cosine transform (IDCT), or a (forward) fast Fourier transform (FFT).

The present invention further provides a sound synthesizer, a sound decoder, a consumer device and an audio system comprising a device as defined above. The sound synthesizer may, for example, be arranged for reproducing sound from stored transform domain data, and may separately synthesize transients, sinusoids and noise. The device of the present invention is particularly suitable for synthesizing sinusoids. The sound decoder may be arranged for reproducing sound from encoded transform domain data, and may also be arranged for separately synthesizing transients, sinusoids and noise.

The consumer device of the present invention may for example be a hand-held device, such as a portable audio player (e.g. an MP3 player) or a mobile (cellular) telephone apparatus, or an electronic musical instrument. The audio system may be a home entertainment system or a professional sound system. Alternatively, the audio system may comprise a speech synthesizer.

The present invention also provides a method of producing time domain sound data from sound parameters, the method comprising the steps of:

forming first frames, each first frame containing sound parameters representing sound,

forming second frames from the first frames, each second frame containing transform domain sound data derived from the sound parameters of a single first frame, the transform domain sound data of each second frame representing sound having a specific time domain length, and each second frame having a length corresponding with an efficient inverse transform,

inversely transforming the second frames into third frames, each third frame containing time domain sound data corresponding to the transform domain sound data of a second frame, and each third frame having a length equal to a second frame,

outputting substantially all time domain sound data of each third frame, and

discarding or repeating first frames as necessary to compensate for any difference between the said a specific time domain length and the length of the third frames.

These method steps are not necessarily carried out in the listed order. For example, the step of discarding first frames may be carried out prior to the step of forming second frames. Alternatively, some first frames may not be formed at all, thus discarding the transform domain sound data prior to forming a first frame. It is noted that only some first frames will be discarded, and that the step of discarding will therefore not be carried out for some frames.

The method of the present invention essentially solves the same problems and achieves the same advantages as the device of the present invention defined above.

The step of forming first frames may involve reducing the specific time duration so that the length of a first frame is at most equal to the length of a second frame. It is preferred that the step of forming first frames involves reducing the specific time duration by at most 40%, preferably at most 25%, more preferably at most 15%, although percentages greater than 40% are also possible if a certain sound distortion is accepted.

The method according to the present invention may further comprise the step of discarding or repeating first frames as necessary to compensate for any length difference between the specific time domain length and the length of the second frames.

The method of the present invention is particularly suitable for synthesizing periodic sound components, for example in a synthesizer which separately produces transient, sinusoidal and noise sound components.

The present invention additionally provides a computer program product for carrying out the method as defined above. A computer program product may comprise a set of computer executable instructions stored on a data carrier, such as a CD or a DVD. The set of computer executable instructions, which allow a programmable computer to carry out the method as defined above, may also be available for downloading from a remote server, for example via the Internet.

### BRIEF DESCRIPTION OF THE DRAWINGS

The present invention will further be explained below with reference to exemplary embodiments illustrated in the accompanying drawings, in which:

FIG. 1 schematically shows a sound data conversion device according to the Prior Art.

FIG. 2 schematically shows a sound data conversion device according to the present invention.

FIG. 3 schematically shows the processing of frames in the sound data conversion devices of FIGS. 1 and 2.

FIG. 4 schematically shows the discarding of frames according to the present invention.

FIG. 5 schematically shows the repetition of frames according to the present invention.

FIG. 6 schematically shows a sound synthesizer comprising a sound data conversion device according to the present invention.

FIG. 7 schematically shows a consumer device comprising a sound data conversion device according to the present invention.

### DETAILED DESCRIPTION OF PREFERRED EMBODIMENTS

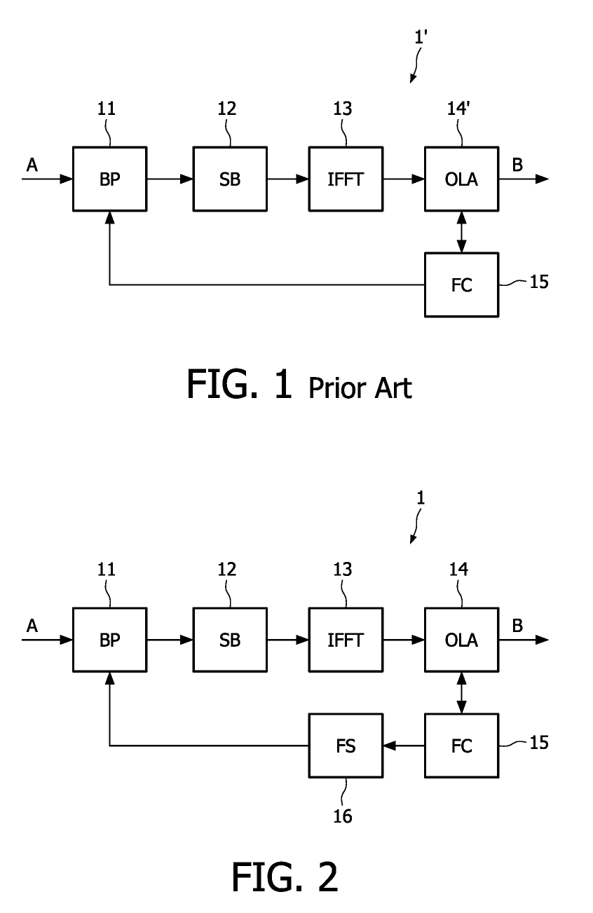

The exemplary sound data conversion device 1′ according to the Prior Art which is shown in FIG. 1 comprises a bitstream parsing unit (BP) 11, a spectrum-building-unit 12, an inverse fast Fourier transform (IFFT) unit 13, an overlap-and-add (OLA) unit 14, and a frame counter (FC) 15.

The bitstream parsing unit 11 receives an input bitstream of sound parameters A and forms first frames containing these sound data. The sound parameters may comprise parameters describing and/or representing temporal or spectral envelopes, spectral coefficients, and/or other parameters. The number of sound parameters per first frame may depend on the particular type of encoding used, and may vary from a single data item to several hundred data items. First frames may have a variable length.

The sound data of a first frame provide a representation of sound during a specific time interval. The duration of this time interval may be chosen to satisfy psycho-acoustic and/or technical constraints and may, for example, be 8.7 ms, although other values may be used instead. This time interval may coincide with the time interval between first frames, although this is not essential.

The spectrum-building-unit 12 uses the samples of the first frames to form second frames having a length that is suitable for the subsequent transform in the transform unit 13. The most efficient FFTs typically have a length of 128, 256, 512, and 1024 (powers of 2), and in the Prior Art the next larger FFT length is used, in the present example 512. The spectrum builder unit 12 therefore converts the first frames, which may contain a variable number of sound data, into second frames, which in the present example each contain 512 spectral components.

To this end, the spectrum-building-unit 12 may convolve the sound data of each first frame with the (complex) spectral representation of a time window. The length of this time window is chosen so as to match the duration of the sound represented by a single frame. In the example above, a time duration of 8.7 ms is used, which at a sampling frequency of 44.1 kHz results in a length of 384 time domain sound data items (samples). The shape of the time window is chosen so as to avoid distortions of the sound, and typically a Hanning window is used. In order to improve the accuracy the (complex) spectrum representation of the time window may be oversampled.

Accordingly, the spectrum-building-unit 12 performs a convolution of the (complex) spectrum of a (Hanning) time window and the sound data of the first frame, resulting in a second frame containing spectral components. The number of spectral components (e.g. 512) is a power of two so as to allow an efficient (inverse) transform. Those skilled in the art will recognize that this convolution in the transform domain may be replaced with a multiplication in the time domain.

The IFFT unit 13 subsequently converts the transform domain second frames into time domain third frames, which have the same length as the second frames and in the present example also contain 512 data items (that is, samples).

The overlap-and-add unit 14′ converts the third frames into a bitstream, a series of frames, or any other suitable output signal containing time domain output sound data B. Those skilled in the art know that overlap-and-add (OLA) units produce a signal by adding the samples of partially overlapping frames.

The frame counter 15 counts the number of frames generated and controls the bitstream parser unit 11 accordingly. The frame counter may also be controlled externally, for example to perform seek operations or to adjust the playback tempo.

The Prior Art overlap-and-add unit 14′ uses only the part of each third frame that corresponds with the original, smaller number of samples. In the present example, the Prior Art overlap-and-add unit 14′ uses only 384 out of 512 samples and discards the remaining 128 samples. It will be clear that this is not efficient.

The sound data conversion device 1 according to the present invention which is shown merely by way of non-limiting example in FIG. 2 also comprises a bitstream parsing unit (BP) 11, a spectrum-building-unit 12, an inverse fast Fourier transform (IFFT) unit 13, an overlap-and-add (OLA) unit 14, and a frame counter (FC) 15. In addition, the embodiment shown comprises a frame selector unit (FS) 16.

In contrast to the Prior Art device 1′ of FIG. 1, the device 1 according to the present invention uses all available data items (samples) of the third frames to produce an output signal. While the units 11, 12, 13 and 15 substantially operate as described above with reference to the Prior Art, the unit 14 of FIG. 2 is modified relative to the corresponding unit 14′ of FIG. 1.

Using the above example, the bitstream parser unit 11 forms first frames containing transform domain data items (e.g. parameters), as in the Prior Art. The spectrum builder unit 12 converts these first frames into second frames having 512 data items by convolving the coefficients represented by the data of the first frame with the (preferably complex) frequency spectrum of a suitable time window, for example a Hanning window having a length of 512 samples, in contrast to the 384 samples of the Prior Art. The second frames are then (inversely) transformed by the IFFT unit 13, resulting in third frames each containing 512 time domain sound data items.

The overlap-and-add (OLA) unit 14 of the present invention, which is designed for outputting the time domain output sound data A, uses all (or nearly all) data items of each third frame to produce the output bitstream. That is, in the example given above the overlap-and-add unit 14 uses all 512 samples of each third frame to produce the output bitstream.

Using all data items of the third frames increases the number of output samples per frame, and thereby increases the time duration of the sound. To obtain sound having its intended duration, the present invention further proposes to skip certain first frames. This has the added advantage that the number of frames to be processed is reduced, thus saving processing time.

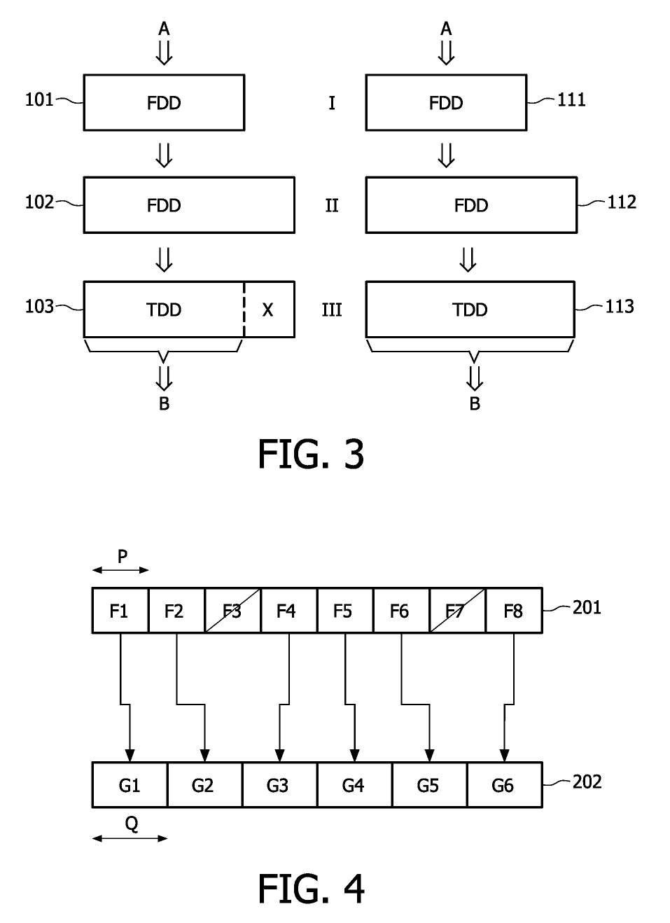

The device 1 of the present invention is provided with a frame selector unit 16, which is controlled by the frame counter 15. The frame selector unit 16 selects first frames which may be processed, discarding those frames which need not to be formed by the bitstream parser 11, in accordance with the ratio of the number of transform domain data items per first frame and the number of transform domain data items per second frame. This will be explained in more detail with reference to FIGS. 3 and 4.

It is noted that instead of, or in addition to, performing a convolution the spectrum-building-unit may used zero-padding or similar techniques to adjust the frame size.

The processing of frames is illustrated in FIG. 3, where the processing according to the Prior Art is shown on the left, and the processing according to the present invention on the right.

According to the Prior Art, an input bitstream A is assembled into first (I) frames 101, which in the present example contain Fourier domain data (FDD), such as (spectral) parameters representing sound, although other parameters, such as envelope parameters, may also be used. The number of data items, and hence the length of the first frames, may vary and is typically less than the length of the corresponding second and third frames.

The first (I) frames 101 are converted into second (II) frames 102 by, for example, convolution with the complex spectrum of a time window. In the Prior Art, this time window is chosen to match the duration of the data represented by transform domain data or parameters of each first frame.

The second frames have a length which corresponds with an efficient transform format and may, for example, contain 512 data items. The second frames are inversely transformed to yield third (III) frames 103 which, in the present example, contain 512 time domain data items (TDD). Then the Prior Art method uses only the original number of samples, that is 384 in the present example, to form the output signal B, discarding the remaining samples (X).

According to the present invention, first frames 111 are formed, convolved to form second frames 112, and inversely transformed to yield third frames 113, as in the Prior Art. However, in contrast to the Prior Art, all data items (that is, samples) of the third frames 113 are used to produce the output signal B, and no samples are discarded. In the above example, this implies that the output bitstream contains 512 samples per frame, instead of the original 384 samples per frame. It will be clear that this increased output per frame makes more efficient use of the transform.

However, as the number of samples which are output per frame has increased, the tempo has decreased and the duration of the sound represented by the output samples has increased. As this is typically undesirable, the present invention proposes to adjust the length of the sound track by discarding (or, in other cases repeating) frames. This is illustrated in FIG. 4.

A block 201 of first frames is shown to contain eight first frames F1, F2, . . . , F8 each representing an original time domain length P (for example 384 samples or 8.7 ms). In accordance with the present invention, these first frames are converted into third frames having an increased time domain length Q (for example 512 samples or 11.6 ms). As a result, the block 202 contains only six frames: G1, G2, . . . , G6. Since the block 202 has the same length (6×512=3072) as the block 201 (8×384=3072) and therefore represents the same sound duration, two of the frames of the first block have to be discarded. In the example shown, frames F3 and F7 are discarded. The discarded frames are preferably not adjacent so as to avoid any noticeable artifacts in the sound. By discarding first frames, or the data corresponding with first frames, the amount of processing is reduced, in the present example by 25%.

It will be understood that the example used above is not intended to limit the invention in any way and that frames having other lengths than 512 and 384 data items may be used instead, for example 256 and 139 data items. It will further be understood that the data items may be input and/or output as frames instead of bitstreams.

In the example of FIGS. 3 and 4, the length of the third frames is greater than the length of the first frames, as the number of data items is increased to match a suitable transform format. According to a further aspect of the present invention, the length of the third frames may also be smaller than the length of the first frames. This will be the case when the number of data items is decreased to match a suitable transform format.

A time window corresponding with a time duration of 8.7 ms, for example, contains 139 data items at a sampling frequency of 16 kHz. When using a transform length of 256 the efficiency of the transform would be only 54% (=139/256). However, if the time duration of 8.7 ms is reduced to 8.0 ms, only 128 data items are required at 16 kHz, and a transform length of only 128 can be used. It will be clear that shortening the frame length significantly improves the transform efficiency.

It is noted that in actual embodiments the length of the time window may be reduced slightly further, for example to 7.9 ms and 126 data items, for technical reasons, for example because the number of data items must be divisible by three. In those cases, in accordance with the present invention all 128 samples of the third frames may be output. Still a significant improvement of the transform efficiency is achieved.

As the duration of the frames may be reduced, the total duration of the sound is reduced, which is usually undesirable. For this reason, the frame selector unit comprises means for repeating first frames as necessary to compensate for any length difference between the first frames and the second frames. By repeating frames, the total duration of the sound which is output can be kept substantially unchanged. In the above example, a time window length reduction from 8.7 to 8.0 ms requires an adjusted length of 8.7/8.0=1.0875 (that is, adding 8.75%), which may for example be achieved by repeating one in every 12 frames (1/12=8.33%).

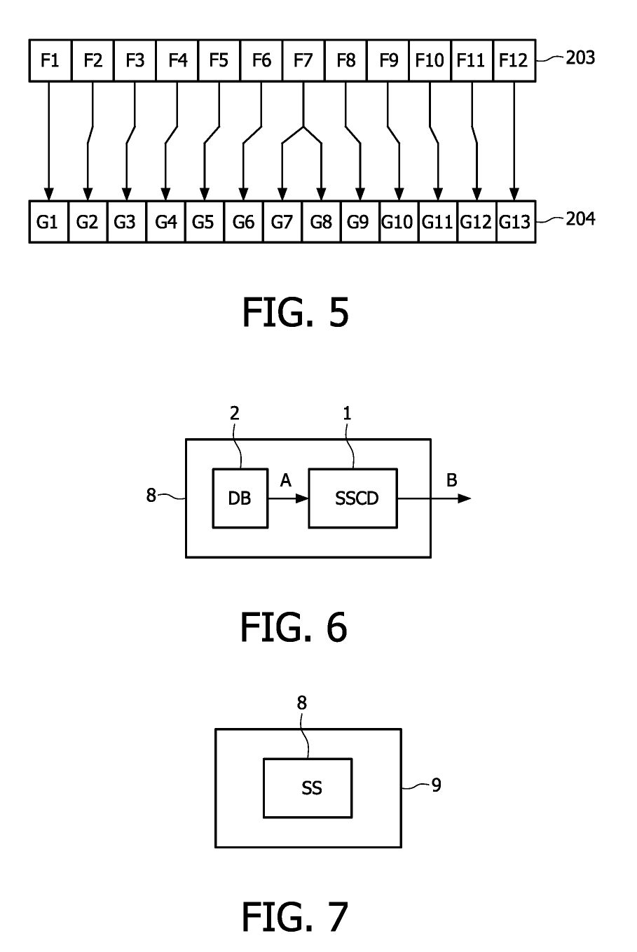

This is illustrated in FIG. 5, where a first block 203 contains 12 (first) frames, while a second block 204 having substantially the same length contains 13 (third) frames. The (first) frames F1, F2, . . . , F12 each contain in the present example 139 data items, while the (third) frames G1, G2, . . . , G1, G1* each contain 128 data items. Accordingly, the blocks 203 and 204 contain substantially the same number of data items (139×12=1668, 128×13=1664). If necessary, this length difference could be compensated by occasionally repeating one more frame.

It can be seen from FIG. 5 that frame F7 is repeated: frame F7 is used to produce both frame G7 and frame G8. In the example of FIG. 5 the double frames G7 and G8 are adjacent to minimize any audible artifacts.

A synthesizer or decoder 8 according to the present invention is illustrated in FIG. 6. The synthesizer or decoder 8 contains a sound data conversion device (SSCD) 1 according to the present invention, as well as a database (DB) 2 for storing sound parameters. The database 2 produces an input bitstream A which is converted by the sound data conversion device 1 into an output bitstream B. The synthesizer or decoder 8 may contain further components which are not shown for the sake of clarity of the illustration, for example components for independently controlling the pitch and the tempo of the sound. The present invention may particularly advantageously applied in parametric decoders.

A consumer device 9 is schematically illustrated in FIG. 7. The consumer device 7 may be a portable consumer device such as a solid-state audio player, for example an MP3 player. The consumer device 7 contains a sound synthesizer 8 as illustrated in FIG. 6. The consumer device 7 may also be a mobile telephone apparatus, a gaming device, a portable music device, or any other device in which sound is to be generated. The sound is not limited to music but may also be speech or ring tones, or a combination thereof.

It is noted that the method of the present invention is illustrated in FIG. 2, where the following units may represent the following method steps:

unit 11 (BP): the step of forming first frames containing sound parameters,

unit 12 (SB): the step of forming second frames from the first frames, the second frames having a length corresponding with an efficient inverse transform,

unit 13 (IFFT): the step of inversely transforming the second frames into third frames,

unit 14 (OLA): the step of outputting time domain output sound data of each third frame,

unit 16 (FS) in conjunction with unit 11 (BP): discarding or repeating first frames.

The present invention is based upon the insight that the efficiency of transforming sound frames may be significantly improved by using the entire (inversely) transformed frame instead of only the part corresponding with an original shorter frame, and then dropping frames to compensate for the increased overall time duration of the sound. The present invention benefits from the further insight that the efficiency may be further improved by reducing or increasing the frame lengths to match a suitable transform length, and then repeating or discarding frames to compensate for the decreased overall time duration of the sound.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents. The term frame is not meant to limit a set of sound data to any specific arrangement. The Fourier transform mentioned above may be substituted with another transform.

It will therefore be understood by those skilled in the art that the present invention is not limited to the embodiments illustrated above and that many modifications and additions may be made without departing from the scope of the invention as defined in the appending claims. For example, the first frame-forming unit may be omitted if the device of the present invention receives first frames containing sound parameters representing sound, thus removing the need to form first frames within the device.

1. A device for producing time domain sound data from sound parameters, the device comprising:
a first frame-forming unit for forming first frames, each first frame containing sound parameters representing sound,
a second frame-forming unit for forming second frames from the first frames, each second frame containing transform domain sound data derived from the sound parameters of a single first frame, the transform domain sound data of each second frame representing sound having a specific time domain length, and each second frame having a length corresponding with an efficient inverse transform,
an inverse transform unit for inversely transforming the second frames into third frames, each third frame containing time domain sound data corresponding to the transform domain sound data of a single second frame, and each third frame having a length equal to a second frame,
an output unit for outputting substantially all time domain sound data of each third frame, and
a frame selector unit for discarding or repeating first frames as necessary to compensate for any difference between the said specific time domain length and the length of the third frames.

2. The device according to claim 1, wherein the second frame-forming unit comprises means for convolving the transform domain sound data represented by the sound parameters with a transform domain representation of a time window having said specific time domain length.

3. The device according to claim 1, wherein the first frame-forming unit comprises means for reducing or increasing the specific time duration so that the length of the specific time duration is substantially equal to the length of a third frame.

4. The device according to claim 3, wherein the first frame-forming unit comprises means for reducing the specific time duration by at most 40%, preferably at most 25%, more preferably at most 15%.

5. The device according to claim 1, wherein the inverse transform is an inverse fast Fourier transform (IFFT).

6. The device according to claim 1, further comprising a frame counter.

7-10. (canceled)

11. A method of producing time domain sound data from sound parameters, the method comprising the steps of:
forming first frames, each first frame containing sound parameters representing sound,
forming second frames from the first frames, each second frame containing transform domain sound data derived from the sound parameters of a single first frame, the transform domain sound data of each second frame representing sound having a specific time domain length, and each second frame having a length corresponding with an efficient inverse transform,
inversely transforming the second frames into third frames, each third frame containing time domain sound data corresponding to the transform domain sound data of a single second frame, and each third frame having a length equal to a second frame,
outputting substantially all time domain sound data (B) of each third frame, and
discarding or repeating first frames as necessary to compensate for any length difference between the said specific time domain length and the length of the third frames.

12. The method according to claim 11, wherein the step of forming first frames involves reducing the specific time duration so that the specific time duration is at most equal to the length of a second frame.

13. The method according to claim 11, wherein the step of forming first frames involves reducing the specific time duration by at most 40%, preferably at most 25%, more preferably at most 15%.

14. The method according to claim 11, wherein the inverse transform is an inverse fast Fourier transform (IFFT).

15. (canceled)
